(19) United States
(12) Patent Application Publication
(10) Pub. No.: US 2003/0214537 A1
(43) Pub. Date: Nov. 20, 2003

(54) Method for displaying multi-dimensional data values

(76) Inventor: Heloise Bloxsom Lynn, Houston, TX (US)

Correspondence Address: Charles Schweppe, LC, 8114 Landau Park Lane, Spring, TX, 77379-7169, US

(21) Appl. No.: 10/150,466

(22) Filed: May 16, 2002

(51) Int. Cl. G09G 5/00

(52) U.S. Cl. 345/835; 345/836

(57) ABSTRACT

A plurality of data locations are selected from a multi-variable data set for multi-dimensional display. Alternatively, a coordinate system is selected for display of the data set. A plurality of data types are selected from the data set. Data values are determined for the plurality of data types at the plurality of data locations. An icon is constructed at the plurality of data locations from selected data values determined from the plurality of data types. The icons constructed at the plurality of data locations are displayed. Alternatively, the icons are displayed changing in time.

This application claims the benefit of U.S. Provisional Application No. ______ (not yet received), filed May 6, 2002.

### BACKGROUND OF THE INVENTION

The patent or application file contains at least one drawing executed in color. Copies of this patent or patent application publication with color drawing(s) will be provided by the Office upon request and payment of the necessary fee.

1. Field of the Invention

This invention relates generally to the field of data visualization. Particularly, the invention is a method for displaying data sets with multi-dimensional data values in multi-dimensional format.

2. Description of the Related Art

Data visualization is a term applied to a variety of non-mental processes for the representation of or the transformation of data or information into understandable images. These images can include graphs, pictures, three-dimensional displays, and movies. Visualization usually refers to the representation of data in the form of digital or numerical information.

A motivation for applying visualization processes is a need or desire to transform a large amount of data into manageable, but still meaningful, proportions. Typical applications include graphical representation of geophysical seismic surveys results; weather satellite data; or medical imaging data from x-rays, cat scans, MRI's (magnetic resonance imaging), or EKG's (electrocardiograph). Visualization has also been applied to business and industrial needs where a number of system variables need to be viewed simultaneously. These applications tend to use tables, bar graphs, and other icons, such as composite curve plots.

Multi-dimensional data sets with a high number of different data types and values defined at each data point have become common in science, engineering, and other fields. Visualization processes to handle these data sets are needed and slowly being developed. The following two patents from the field of geophysics illustrate the uses of visualization.

Marfurt, Kurt J., et al., in their U.S. Pat. No. 5,930,730, “Method and apparatus for seismic signal processing and exploration”, issued Jul. 27, 1999; describe a method for determining and displaying a set of three specific seismic attributes from a three-dimensional seismic data volume onto a two-dimensional map using color. The method is restricted to the three particular attributes of apparent (assumed to represent true) dip, apparent (assumed to represent true) dip azimuth, and semblance or similarity. These three specific attributes are calculated in a three-dimensional grid of cells in the seismic data volume and mapped onto the hue, saturation, and lightness scales, respectively, of a two-dimensional color map.

Alam, M. Aftab, in his U.S. Pat. No. 6,278,949, “Method for multi-attribute identification of structure and stratigraphy in a volume of seismic data”, issued Aug. 21, 2001, describes a method for determining and displaying functions of multiple seismic attributes from a three-dimensional seismic data volume onto a two-dimensional animated map using color and sound.

There are a vast number of scientific and socio-economic mathematical problems that rely upon the knowledge of the interaction of N-dimensional numbers that exist within a three-dimensional (or even four-dimensional) grid. Thus, a need exists for a tool to enable the human mind to grasp and understand the manipulation of N-dimensional numbers within a three- or four-dimensional grid is needed. By extension, the understanding of the two-dimensional grid of N-dimensional numbers is a trivialization of this. Thus, a need exists for a method for displaying a data set with multi-dimensional data values in a multi-dimensional format.

There are a vast number of scientific and socioeconomic mathematical problems that rely upon the knowledge of the interaction of N-dimensional numbers that exist within a three-dimensional (or even four-dimensional) grid. The three dimensions are customarily, though not necessarily, taken as the three space variables of height, width, and depth, on a Cartesian coordinate system, traditionally represented by X, Y, and Z. A three-dimensional Cartesian grid is not the only three-dimensional grid available. Either a cylindrical or spherical coordinate system is possible, as well as many others. Four dimensions may also be used. The flow of time is usually taken as the progression through the fourth dimension. Nonetheless, other choices are possible, especially for the oil and gas industry. For example, progression through the fourth dimension could represent temperature changing from high to low or pressure changing from high to low. Thus, a need exists for a tool to enable the human mind to understand the disposition in 3D space of N-dimensional numbers and to understand the manipulation of N-dimensional numbers within a three- or four-dimensional grid. By extension, the understanding of the two-dimensional grid of N-dimensional numbers is a trivialization of this. A need exists for a method to display a three- or four-dimensional data set containing multi-dimensional data values. Once the data are displayed, their significance and interpretation can commence and their manipulation can be achieved in a correct fashion.

### BRIEF SUMMARY OF THE INVENTION

The invention is a method for displaying a data set with multi-dimensional data values in a multi-dimensional format. A plurality of data locations are selected from the data set. A plurality of data types are selected from the data set. Data values are determined for each of the plurality of data types at each of the plurality of data locations. An icon is constructed at each of the plurality of data locations from each of the data values determined at each of the plurality of data types. The icons constructed at each of the plurality of data locations are displayed.

In an alternative embodiment, a coordinate system is selected for display of the data set.

In a further alternative embodiment, the icons displayed at each of the plurality of data locations are displayed as the icons change over time.

### BRIEF DESCRIPTION OF THE DRAWINGS

The invention and its advantages may be more easily understood by reference to the following detailed description and the attached drawings, in which:

FIG. 1 is a flowchart illustrating the processing steps of an embodiment of the method of the invention for displaying multidimensional data sets in a three-dimensional format;

FIG. 2 is an example of a two-dimensional icon display; and

FIG. 3 is an example of a three-dimensional icon display.

While the invention will be described in connection with its preferred embodiments, it will be understood that the invention is not limited to these. On the contrary, the invention is intended to cover all alternatives, derivatives, modifications, and equivalents that may be included within the scope of the invention, as defined by the appended claims.

### DETAILED DESCRIPTION OF THE INVENTION

The invention is a method of data visualization. More particularly, the invention is a method for displaying data sets with multi-dimensional data values in a multi-dimensional format. An N-variable data set contains data values for N data types at each data location. The invention can display an N-variable data set in a three-dimensional spatial format. In an alternative embodiment, the invention can display a two-dimensional map or slice from the three-dimensional display of the N-variable data set. In an additional alternative embodiment, the invention can display an additional N+1^{st} data type in the time dimension.

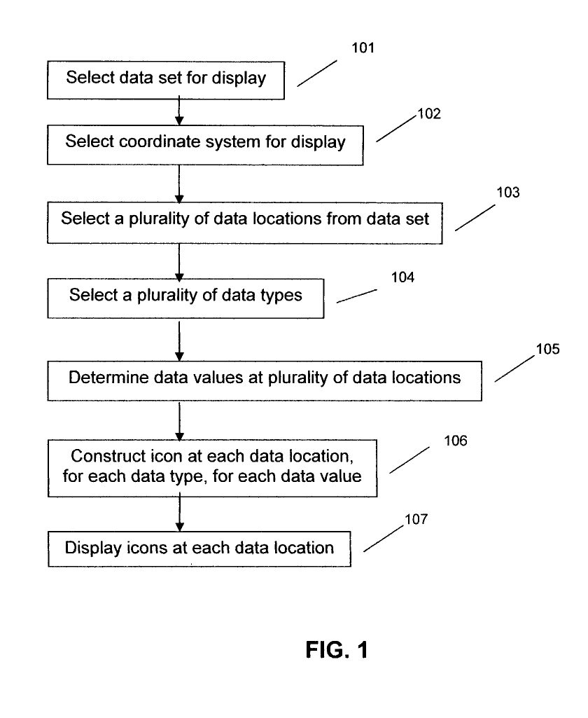

FIG. 1 shows a flowchart illustrating the processing steps of an embodiment of the method of the invention for displaying data sets with multi-dimensional data values in a multi-dimensional format.

First, at step 101, a data are selected for display. The data selected comprise an M-dimensional set of data locations with an N-dimensional set of data values defined at substantially each data location. The invention applies to any data set, but is can be illustrated for data sets with three-dimensional sets of data locations and more than three data values defined at substantially each data location. This corresponds to M=3 and N>3. The invention will be illustrated in terms of three-dimensional sets of data locations. The invention also applies, however, to data sets with one- or two-dimensional sets of data locations, with simple modifications to the following procedures.

The N data values in the data set could be of any type. The data to fill the M-dimensional grids of N-dimensional data values should be understood to come from any field, including, but not limited to, scientific, technical, human cultural or biological fields. For instance, the types of data that the invention could be applied to could include, but are not restricted to, the following sources:

1. Hydrocarbon and mining industry exploration and production activities, including, but not be limited to, geophysical, geologic, reservoir engineering, and petrophysical data. These could include both field data and model synthetic data. As an example, the geophysical data, in terms of seismic reflection data, could include both PP and PS reflection wave fields, thus allowing the inclusion of anisotropic quantities of interest. Additionally, this could include any combination of the above, or any other, useful data types.

2. Weather studies, including, but not be limited to, climate and atmospheric circulation and movement studies.

3. Earth sciences, including, but not be limited to, studies of earthquake, stress, and failure states in the upper and lower crusts; circulation in the mantle and core, and interaction between core, mantle, and crust. This could also include plate tectonic studies, dealing with the movement of the continental plates throughout geologic time or geologic studies dealing with the formation of the earth and its evolution.

4. Material sciences, including, but not be limited to, stress states and failure states studies.

5. Engineering studies.

6. Biological sciences, including, but not limited to, medical imaging, evolution studies, and genetics.

7. Satellite data processing, including, but not limited to, visualization of satellite images, satellite data, wherein the satellite data show various scan-bandwidths of activity (such as human activity, heat, reflectivity in various bands), movement of the land's surface elevation, etc.

8. Ocean science, including, but not limited to, fluid dynamics of oceans, rivers, lakes, and oceans.

9. Studies of turbulence and chaos theory.

10. Cosmology, including, but not limited to, astronomy, string theory, galaxy evolution, the interactions of comets, planets, and sun(s) in a solar system; the modeling of our solar system for the last 660 million years (to include the two massive life-form die-offs, at the end of the Paleozoic, and the end of the Mesozoic), the history of the universe from the Big Bang onwards, or any particular subset of time or space wherein galactic evolution of a segment of time or space is viewed, explored, studied or analyzed.

11. Economic trends, including, but not limited to, the stock market.

12. History, including, but not limited to, political and historical forces or trends and the psychology of large groups of people.

For illustrative clarity only, the invention will be disclosed in terms of seismic reflection data sets comprising multiple seismic attributes. However, the invention is not limited to seismic data.

Continuing with FIG. 1, at step 102, a three-dimensional coordinate system is chosen for the display of the data set selected in step 101. The invention is typically used as a three-dimensional visualization scheme for displaying multi-dimensional data values in a three-dimensional coordinate system. Typically, this three-dimensional coordinate system would be a three-dimensional Cartesian coordinate grid. The three-dimensional grid is envisioned as representing a spatial portion of the earth. There is an X horizontal axis and a Y horizontal axis. In the seismic data example, the X- and Y-axes usually correspond to the inline and crossline directions from the seismic survey used to collect the data. They are not restricted to this, however, and could correspond to any two coordinate axes that are desired. There is also a vertical axis stretching down into the earth. The vertical axis is typically either termed T for time or two-way travel time or termed Z for depth. Again, the third axis is not restricted to this and can be any axis that completes a desired coordinate system. The three-dimensional grid does not have to be an earth-like entity: The grid can be defined by any three-dimensional coordinate system that is desirable. For example, a polar coordinate system (spherical coordinate system) may be preferred as more appropriate for the data types being visualized. Alternatively, a cylindrical coordinate system may be preferred. The invention includes any coordinate system. Preferably, the coordinate system used is the coordinate system that fits the natural symmetry (internal order) of the data types being displayed. Great simplicity and understanding is reached if one works within a naturally appropriate coordinate system. The natural coordinate system is typically the coordinate system aligned with the internal symmetries.

Continuing with FIG. 1, at step 103, a plurality of data locations are selected from the data set selected in step 101, as defined by the coordinate system selected in step 102. The plurality would preferably comprise all the data locations in the data set. However, the invention is not restricted to this. Any appropriate set of data locations may be selected. Preferably, the selected plurality of data locations would sufficiently cover the data set so that display would aid in understanding of the data set.

For instance, horizons of interest in the seismic volume of reflection amplitudes could be mapped. This could define a possible plurality of data point to examine. Faults of interest as well as the horizon surfaces could be mapped.

At step 104, a plurality of data types are selected, from the data set of step 101. Any or all of the data types present in or further derived from the data set may be selected for display. Data types are selected for their possible contribution to understanding the data set as a whole. The number of data types selected for display is not limited by the invention. The invention enables the visualization of multiple co-rendered volumes of attributes, each existing as a three-dimensional volume

One example of the use of the invention is in the application to seismic reflection data. The set of data locations in the data set is defined by the coordinate system selected in step 102. This coordinate system is typically a three-dimensional orthogonal grid defined by the inline and crossline directions and the travel time (or corresponding calculated depth) from a three-dimensional seismic PP wave survey. The data values stored at each grid point could include, although is not limited to, the following:

1. The fast interval velocity, V_{f}.

2. The azimuth of the fast interval velocity.

3. The azimuthal variation of the interval velocity, herein written as the difference between the fast and slow interval velocities, V_{f}−Vₛ.

4. The maximum near-offset amplitude or AVO (amplitude variation with offset or angle) gradient. Near offset refers to angles of incidence of 5 to 30 (+/−5 or 10) degrees.

5. The azimuth of the maximum near-offset amplitude or AVO gradient.

6. The azimuthal variation of the maximum near-offset amplitude or AVO gradient, herein written as the NAₘₐₓ−NAₘᵢₙ.

7. The maximum far-offset amplitude or AVO (amplitude variation with offset or angle) gradient. Near offset refers to angles of incidence of 30-45 (+/−5 or 10) degrees.

8. The azimuth of the maximum far-offset amplitude or AVO gradient.

9. The azimuthal variation of the maximum far-offset amplitude or AVO gradient, herein written as FAₘₐₓ−FAₘᵢₙ.

Also, typically the stacked amplitude (or the migrated amplitude, whether prestack or poststack migration) could also be written if desired, which would yield a tenth data type.

These data values exist in a set of data locations in three dimensions, but are depicted on a sheet of paper, computer screen, or other media in two dimensions. The structure of a formation boundary of interest is used as the background template. The formation boundary of interest defines the plurality of data locations of interest. So, for every CMP bin (node point) on the map, 10 bits of information are displayed (the nine listed above, plus the structure or attitude in the three-dimensional space of a reflector).

The number of data types selected for display at each grid point of the three-dimensional grid is limited only by the capability of the viewer to visualize the relationships between the multiple data types. The following is an example of a 24-dimensional set of data values from seismic surveys that would be useful to study all at once. These data values are stored at the grid points of a three-dimensional grid. The 24 data values are the following:

1. The three Interval Velocity numbers.

2. The three Near-Amplitude numbers.

3. The three Far-Amplitude numbers.

4. The three “3-rd term” (really far offset) Amplitude numbers.

5. The three “quartic”, “eta”, or “hockey stick” travel time information (related to the layer anisotropy and the azimuthal anisotropy, the far-offset travel time information.

6. The three “frequency” numbers (local maximum instantaneous frequency, the direction of the local maximum instantaneous frequency, and the difference between Fₘₐₓ and Fₘᵢₙ).

7. The local maximum RMS error and the azimuth of the local maximum RMS error for the Interval velocity volume, the NA, the FA volumes. The RMS error is to be understood as coming from an estimate of the deviation between the field data and the fit model. The error is measured in a sampling of azimuths, the largest error found and stored, and its azimuths are each stored as three-dimensional volumes. Thus, this last item entails six numbers.

Continuing with FIG. 1, at step 105, data values are determined at each of the plurality of data locations selected in step 103, for each of the plurality of data types selected in step 104. The data set can be determined by any means. As an example, but not a limitation, the data values could be empirically collected in field studies, synthetically derived from model studies, calculated from other data values, or a combination of any of the above, including any weighted hybrid cross: wherein the data values are superimposed.

In an alternative embodiment, derivative icon volumes are calculated by averaging properties of the icon volumes over the time windows (time intervals or depth intervals, or any set of numbers) wherein the average property is desired, as opposed to the point properties of the icons. There are many situations in which the viewer wishes to capture either two-dimensional or three-dimensional zones wherein the average is displayed. Calculation of the average could include, but not be restricted to, the median or other statistical quantification, mean, mode, or standard deviation, or spatial variogram. The invention includes the use of the icon volumes to calculate derivative volumes wherein either spatial smoothing or averaging in time or space or any 1, 2, 3, or 4 dimensions is accomplished.

At step 106, an icon is constructed at each of the plurality of data locations selected in step 103, from each of the data values determined in step 105, for each of the plurality of data types selected in step 104. The icon is a symbol upon which are represented the data values for display. The icon can be two-, three-, or four-dimensional. The icon can hold three, four, or five bits of information.

A two-dimensional icon is preferably displayed as a two-dimensional symbol or object. For example, this would include, but not be limited to, a colored arrow, a colored rectangular bar, a colored triangle (like an arrowhead), or a colored ellipse. A two-dimensional icon fits onto a piece of paper with no loss of information. The use of the word color is to be understood as intrinsically having three pieces of information, as the term color is used in the open literature. The three pieces of information carried by the color is the hue (red to cyan), the amount of black added, and the amount of white added. Typically, black is used to carry the RMS error (or lessened-confidence). Thus, a large error (deviation of the field data from the model used in processing) would be indicated by adding more black to the color. The hue carries information, such as a data value of interest. A two-dimensional icon can display from three to eight data values or pieces of information.

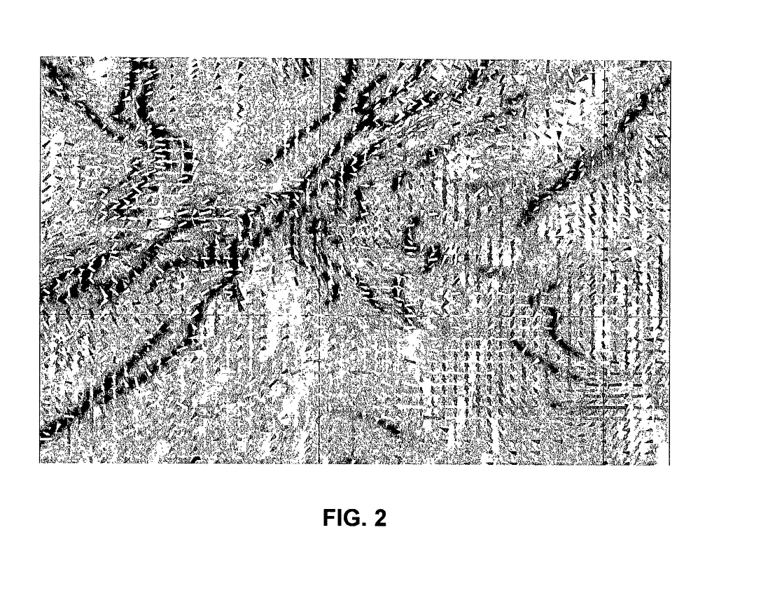

FIG. 2 is an example of a two-dimensional icon display. FIG. 2 shows a two-dimensional slice through a three-dimensional volume filled with two-dimensional icons in the form of colored arrows, bars, and triangles.

As an example of an icon, consider a colored arrow. Such an arrow could be used to represent interval velocity. The length of the arrow could represent the magnitude of the azimuthal variation. The color of the arrow could represent the value of the large interval velocity. The direction of the arrow could represent the direction of the fast interval velocity.

A three-dimensional icon is preferably displayed as a three-dimensional symbol or object. For example, this would include an oblate spheroid (which can be seen as a squished elongated tennis ball). This would carry six pieces of information, for it is essentially a horizontal ellipse (a two-dimensional object) coupled with a vertical ellipse (another two-dimensional object). Thus, a viewer can see two ellipses at the same time if a proper viewing platform is used. The proper viewing platform is discussed further below in step 107. Further examples of a three-dimensional icon would include, but not be limited to, a three-dimensional star, a three-dimensional rectangular box, or any symbol that has three dimensions equivalent to height, width, and depth. For example, a colored arrow lying in the horizontal plane co-rendered with its companion colored arrow lying in the vertical plane could be a three-dimensional icon. By extension, it is possible to have three orthogonal colored arrows, or any three icons, associated with each grid point. Each of the three icons has three pieces of information on it, so that this symbol carries nine pieces of information. When three icons are co-rendered, that three-dimensional icon carries nine pieces of information and is viewed as a three dimensional symbol. A three-dimensional icon can display from six to 12 data values.

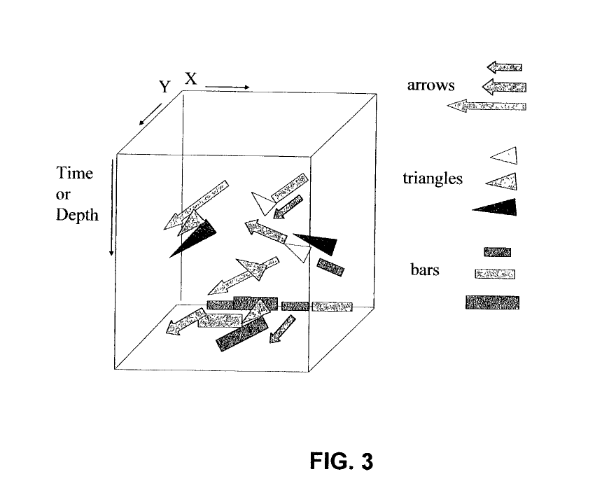

FIG. 3 is an example of a three-dimensional display of two-dimensional icons. FIG. 3 shows a three-dimensional grid with nine-dimensional numbers. Each three-dimensional icon holds three pieces of information, the large value, the azimuth of large value, and the azimuthal variation of value. The three-dimensional volume is filled with three-dimensional icons in the form of colored arrows, bars, and triangles

A four-dimensional icon is preferably displayed as a four-dimensional symbol or object. This is typically a three-dimensional symbol displayed as changing in time, the fourth dimension. As time changes, so does this icon, as in a movie. The change in the icon over time is itself a data value of interest. The fourth dimension, however, does not have to be time. The fourth dimension could be understood to be another data value, such as pressure. As pressure changes, so do the other data values, and thus, so does the icon. The fourth dimension could be understood to be any data value that causes a change in the observed phenomena of interest, as the phenomena change over time. The use of four-dimensional icons is discussed further in alternative step 108, below.

Continuing with FIG. 1, at step 107, the icons constructed in step 106 are displayed at each of the plurality of data locations selected in step 103. More than one icon could be displayed at each data location. The invention is a visualization tool used to view and study the M-dimensional grids of N-dimensional numbers (with M=3, usually). So the invention is typically used for three-dimensional volume visualization. When 9-dimensional data values are stored in the three-dimensional grid, then nine controls on the visualization scheme govern the opacity in the three-dimensional grid. If 12 dimensional data values are stored in the three-dimensional grid, then 12 controls are needed, et cetera. The number of controls equals the numbers of dimensions. If the user directs the coupling of any of the dimensional adjustments of opacity, for ease of interpretation or understanding, then this can be done.

The invention includes the use of hodograms to view three-dimensional grids of two-, three-, and four-dimensional icons. A similar method for governing opacity is needed, as discuss just above. The invention also includes the use of movies or any system, whether computer driven or not, in which flickering images carry the N-dimensional data values, and the three-dimensional spatial relationship between the fields of numbers is visible. Additionally, the four-dimensional relationships between the fields of data values (the time-lapse effects) can be depicted, studied, analyzed, and the resulting new knowledge captured via new equations to describe the relationships between the dimensions.

In an alternative embodiment, at step 108, the icons displayed in step 107 at each of the plurality of data locations is displayed as the icons change over time. The purpose is to see, study and understand the change over time of the multi-dimensional data values as viewed in three or less dimensions. The data values displayed in three-dimensional space change upon the application of a perturbation. The perturbation may be a change in the applied stress field, a change in a local stress field, a change in a local velocity, or amplitude. The perturbation may be envisioned as a change in an initial model, and then the recalculation of the resultant seismic response, or any modeled response. The change in time may also be understood in the time-lapse sense of three-dimensional seismic data, using either multi-component (PP and PS) or only PP reflection data, or both, or some combination thereof, in both the field data sense and the model synthetic data sense. In the time-lapse sense of field data (PP and or PS and or some combination therein), the change in the earth that being visualized is attributed to the changes in pressure or fluid saturation distributions, or some combination thereof, caused by the (human—related) activities of production (injection or withdrawal of fluids or substances into or out of the hydrocarbon reservoir, or the vicinity of the reservoir).

To then calculate the effect upon all the neighboring data values when a change of one or more of the data values existing within one or more of the dimensions of these N dimensional data values is imposed. A neighboring data value is to be understood as some or all grid points within the three-dimensional volume. The number of neighboring points affected by the perturbation is related to the magnitude of the perturbation, and to the properties of the matter at hand. A perturbation in the system can thus be implemented and the response of the system to the perturbation can thus be visualized. The ability to visualize the change is dependent upon the capability of the viewer to hold the significance of the N-Dimensions and understand it.

As one example of usefulness, the invention can be used to detect, characterize, locate, and manage the re-charging hydrocarbon reservoir. The recharging hydrocarbon reservoir is undergoing active re-filling from the organic kitchens below it, or to the side of it, and the hydrodynamic properties of the system are bringing new hydrocarbons into the reservoir. The recharging reservoir is understood as the “active reservoir”. The invention also includes the use of this technology to detect, characterize, and locate the paleo-charged (fossil) hydrocarbon reservoirs: a reservoir not seen to be actively undergoing recharge. Also included is the use of this invention to examine, map, and document the plumbing of the hydrocarbon reservoir: by that is meant the connected porosity conduits within the reservoir, through which fluids flow. The fluids flow through the porous zones, under the response of the stress (or pressure) fields. The fluids typically flow from high-pressure regions to low pressure regions. The use of three-dimensional PP full-azimuth full-offset reflection seismic data (with or without the co-use of the multi-component PS wave field acquired at the same time or at a different time as the PP data set) to map, delineate, and understand the plumbing of the reservoir may be referred to as seismic permeability, and this term is also included.

It should be understood that the preceding is merely a detailed description of specific embodiments of this invention and that numerous changes, modifications, and alternatives to the disclosed embodiments can be made in accordance with the disclosure here without departing from the scope of the invention. The preceding description, therefore, is not meant to limit the scope of the invention. Rather, the scope of the invention is to be determined only by the appended claims and their equivalents.

I claim:

1. A method for displaying a multi-variable data set in a multi-dimensional format, comprising:
selecting a plurality of data locations from the data set;
selecting a plurality of data types from the data set;
determining data values for the plurality of data types at the plurality of data locations;
constructing an icon at the plurality of data locations from the data values determined at the plurality of data types; and
displaying the icons constructed at the plurality of data locations.

2. The method of claim 1, wherein the step of selecting a plurality of data locations further comprises:
selecting a coordinate system for display of the data set.

3. The method of claim 1, further comprising:
displaying the icons at the data locations as the icons change in time.

4. The method of claim 2, wherein the change in time represents change in any one-dimensional parameter.

5. The method of claim 1, wherein the icon is a two-dimensional symbol.

6. The method of claim 1, wherein the icon is a three-dimensional symbol.
